(19) United States
(12) Patent Application Publication
(10) Pub. No.: US 2015/0373667 A1
(43) Pub. Date: Dec. 24, 2015

(54) METHOD TO REDUCE PAGE MISSES IN MULTI-SIM USER EQUIPMENT BY SPLIT ACQUISITION

(71) Applicant: QUALCOMM Incorporated, San Diego, CA (US)

(72) Inventors: Anand Rajurkar, Hyderabad (IN); Aritra Ukil, Hyderabad (IN); Dhananjaya Sarma Ponukumati, Hyderabad (IN)

(21) Appl. No.: 14/311,169

(22) Filed: Jun. 20, 2014

(51) Int. Cl. H04W 68/02

(52) U.S. Cl. CPC H04W 68/02

(57) ABSTRACT

Systems and methods are described for acquiring a first radio access technology (RAT), by segmenting an acquisition process of the first RAT into a plurality of chunks; executing a first chunk of the acquisition process; executing at least one portion of a paging process for paging a second RAT after the first chunk has been executed and before a second chunk is executed; and executing a second chunk of the acquisition process. Each of the plurality of chunks includes a portion of the acquisition process.

### BACKGROUND

1. Field

Embodiments described herein generally relate to radio access technology (RAT), and more specifically, to RAT acquisition and paging.

2. Background

A user equipment (UE), such as a mobile phone device, may be enabled for one or more radio access technologies (RATs), such as GSM, CDMA, CDMA2000, TDCDMA, TDSCDMA, WCDMA, TDMA, FDMA, LTE, VoLTE, SGLTE, SVLTE, and/or the like. One or more RATs may be enabled by one, or a plurality of subscriber identity modules (SIMs). For example, a UE may be a multi-SIM UE, where each of a plurality of SIMs received or otherwise coupled to the multi-SIM UE may support one or more RATs.

The service acquisition of RATs involves a series of steps, and one or more of the steps may take a considerable amount of time to perform. Thus, an entire acquisition process, from beginning to end, may take a long time as compared to other processes. For example, a process for acquiring WCDMA may take 250 ms or more. During the acquisition process, a set of RF resources may be configured to tune to the RAT that is being acquired.

Therefore, the long acquisition time of one RAT may deprive other RATs the use of the set of RF resources of the UE for so long, that other RATs may miss pages (e.g., have a low paging success rate). This may occur when the other RATs may require the set of RF resources for their own purposes, when the set of RF resources is tuned to the RAT that is being acquired. Thus, the long acquisition time described may interfere with performance or services of other RATs. Accordingly, user experience may be hindered in this manner.

### SUMMARY

Various embodiments relate to the acquisition of one first radio access technology (RAT) and allow for improved success in paging of other RATs, by, for example, breaking up acquisition process of the first RAT (such as, but not limited to, WCDMA) into multiple “chunks,” and allow one or more of the other RATs (such as, but not limited to, GSM) to receive/send pages between the chunks. Thus, as the one or more other RATs may obtain an opportunity to use the RF resources without standby by until the acquisition of the first RAT is complete, higher paging success rate of the others RATs may be achieved. In addition, safeguards described herein that are related to prevent the acquisition samples of the first RAT from becoming stale.

Embodiments described herein relate to systems and methods for acquiring a RAT, comprising segmenting an acquisition process of the first RAT into a plurality of chunks; executing a first chunk of the acquisition process; executing at least one portion of a paging process for paging a second RAT after the first chunk has been executed and before a second chunk is executed; and executing the second chunk of the acquisition process, wherein each of the plurality of chunks comprises a portion of the acquisition process.

According to some embodiments, the segmenting includes defining a preemption point between the first chunk and the second chunk; and the executing the at least one portion of the paging process for paging the second RAT includes executing the at least one portion of the paging process for paging the second RAT at the preemption point.

According to some embodiments, the acquisition method still further includes determining a paging time interval; and the executing the at least one portion of the paging process for paging the second RAT includes executing the at least one portion of the paging process for paging the second RAT within the paging time interval.

According to some embodiments, the paging time interval is determined based, at least in part, on signal condition.

According to various embodiments, the executing the at least one portion of the paging process for paging the second RAT includes tuning RF resources away from the first RAT; and tuning the RF resources to the second RAT.

According to some embodiments, the acquisition method further includes executing the at least one portion of the paging process for paging the second RAT comprises receiving a page for the second RAT from a network associated with the second RAT.

According to some embodiments, the acquisition method further includes defining the acquisition process of the first RAT as a plurality of stages, wherein the acquisition process is segmented based, at least in part, on the defined plurality of stages.

According to some embodiments, the plurality of stages comprises one or more of 1) determining the slot timing, 2) determining the frame timing, 3) searching for pseudo-noise sequence, 4) pulling in frequency, 5) listing search results, 6) triaging, 7) setting up a primary common control physical channel, 8) transmitting time interval determination, 9) reading one or more master information blocks, and 10) reading one or more system information blocks.

According to some embodiments, the segmenting the acquisition process includes grouping at least one stage of the plurality of stages in each chunk of the plurality of chunks.

According to some embodiments, the segmenting the acquisition process includes: grouping the determining slot timing, the determining frame timing, and the searching for pseudo-noise sequence in a first chunk; grouping the pulling in frequency in a second chunk; grouping the listing search results, the triaging, the setting up a primary common control physical channel, the transmitting time interval determination, and the reading one or more master information blocks in a third chunk; and grouping the reading one or more system information blocks in a fourth chunk.

According to some embodiments, the acquisition process is segmented based, at least in part, on processing time.

According to some embodiments, the first RAT and the second RAT are a same RAT.

According to some embodiments, the first RAT and the second RAT are separate RATs.

According to some embodiments, the first RAT and the second RAT are associated with a same subscription.

According to some embodiments, the first RAT and the second RAT are associated with separate subscriptions.

According to some embodiments, the acquisition method further includes: monitoring a time period in which the second RAT is being paged; and restarting the acquisition process when the monitored time period exceeds a predetermined threshold.

According to some embodiments, the acquisition method further includes executing at least one portion of one or more additional paging processes at the preemption point, each additional paging process for paging an additional RAT.

According to some embodiments, the acquisition method further includes determining an additional paging time interval associated with the each additional paging process; and executing the at least one portion of each additional paging process within the additional paging time interval.

According to various embodiments, a system for acquiring a RAT including at least one set of RF resources; and a processor configured to: segment an acquisition process of the first RAT into a plurality of chunks; execute a first chunk of the acquisition process; execute at least one portion of a paging process for paging a second RAT after the first chunk has been executed and before a second chunk is executed; and execute the second chunk of the acquisition process, each of the plurality of chunks comprises a portion of the acquisition process.

According to some embodiments of the system, to segment includes to define a preemption point between the first chunk and the second chunk; and to execute the at least one portion of the paging process for paging the second RAT includes to execute the at least one portion of the paging process for paging the second RAT at the preemption point.

According to some embodiments of the system, the processor is further configured to: determine a paging time interval; and to execute the at least a portion of the paging process for paging the second RAT comprises to execute the at least one portion of the paging process for paging the second RAT within the paging time interval.

According to some embodiments of the system, the paging time interval is determined based, at least in part, on signal condition.

According to various embodiments of the system, to execute the at least one portion of the paging process for paging the second RAT includes to tune the at least one set of RF resources away from the first RAT; and to tune the at least one set of RF resources to the second RAT.

According to some embodiments of the system, to execute the at least one portion of the paging process for paging the second RAT includes to receive a page for the second RAT from a network associated with the second RAT.

According to some embodiments of the system, the acquisition process of the first RAT is defined as a plurality of stages, wherein the acquisition process is segmented based, at least in part, on the defined plurality of stages.

According to various embodiments of the system, the plurality of stages comprises one or more of 1) determining the slot timing, 2) determining the frame timing, 3) searching for pseudo-noise sequence, 4) pulling in frequency, 5) listing search results, 6) triaging, 7) setting up a primary common control physical channel, 8) transmitting time interval determination, 9) reading one or more master information blocks, and 10) reading one or more system information blocks.

According to some embodiments of the system, to segment the acquisition process comprises to group at least one stage of the plurality of stages to each chunk of the plurality of chunks.

According to some embodiments of the system, to segment the acquisition process comprises: to group the determining slot timing, the determining frame timing, and the searching for pseudo-noise sequence in a first chunk; to group the pulling in frequency in a second chunk; to group the listing search results, triaging, the setting up a primary common control physical channel, the transmitting time interval determination, and the reading one or more master information blocks in a third chunk; and to group the reading one or more system information blocks in a fourth chunk.

According to some embodiments of the system, the processor is further configured to: monitor a time period in which the second RAT is being paged; and restart the acquisition process when the monitored time period exceeds a predetermined threshold.

According to various embodiments, a system for acquiring a RAT includes means for segmenting an acquisition process of the first RAT into a plurality of chunks; means for executing a first chunk of the acquisition process; executing at least one portion of a paging process for paging a second RAT after the first chunk has been executed and before a second chunk is executed; and means for executing a second chunk of the acquisition process. Each of the plurality of chunks comprises a portion of the acquisition process.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the various embodiments.

FIG. 1 is a schematic diagram illustrating an example of a system according to various embodiments.

FIG. 2 is a functional block diagram illustrating an example of a user equipment according to various embodiments.

FIG. 3 is a process flowchart illustrating a split acquisition process for acquiring one radio access technology and paging another radio access technology according to various embodiments.

FIG. 4 is a block diagram illustrating an example of a split acquisition process according to various embodiments.

FIG. 5 is a process flowchart illustrating a WCDMA split acquisition process for acquiring WCDMA and paging GSM according to various embodiments.

FIG. 6 is a block diagram illustrating an example of a WCDMA split acquisition process according to various embodiments.

FIG. 7 is a process flowchart illustrating an example of a split acquisition process for acquiring one radio access technology and paging two other radio access technologies according to various embodiments.

FIG. 8 is a block diagram illustrating an example of a split acquisition process for one radio access technology and paging two other radio access technologies according to various embodiments.

FIG. 9 is a process flowchart illustrating an example of a stale sample prevention process for acquiring a radio access technology and preventing stale acquisition samples.

FIG. 10 is a component block diagram of a user equipment suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the invention or the claim.

Some modern communication devices, referred to herein as user equipment (UE), such as smart phones, tablet computers, and laptop computers, may contain one or more subscriber identity modules (SIMs) that provide users of the UEs with access to one or multiple separate mobile networks, supported by radio access technologies (RATs). The UE may also be referred to as a mobile station (MS). Examples of UE include, but are not limited to, mobile phones, laptop computers, smart phones, and other mobile communication devices of the like that are configured to connect to one or more RATs. Examples of RATs may include, but are not limited to, Global Standard for Mobile (GSM), Code Division Multiple Access (CDMA), CDMA2000, Time Division Code Division Multiple Access (TDCDMA), Time Division Synchronous Code Division Multiple Access (TDSCDMA), Wideband Code Division Multiple Access (WCDMA), Time Division Multiple Access (TDMA), Frequency Division Multiple Access (FDMA), Long-Term Evolution (LTE), Voice over LTE (VoLTE), Simultaneous GSM and LTE (SGLTE), Simultaneous Voice and LTE (SVLTE), and/or the like.

Embodiments described herein related to both single-SIM and multi-SIM UEs. A UE that includes a plurality of SIMs and connects to two or more separate RATs using a same set of RF resources (e.g., radio-frequency (RF) transceivers), is a multi-SIM-multi-standby (MSMS) communication device. In one example, the MSMS communication device may be a dual-SIM-dual-standby (DSDS) communication device, which may include two SIM cards/subscriptions that may both be active on standby, but one is deactivated when the other one is in use. In another example, the MSMS communication device may be a triple-SIM-triple-standby (TSTS) communication device, which includes three SIM cards/subscriptions that may all be active on standby, where two may be deactivated when the third one is in use. In other examples, the MSMS communication device may be other suitable multi-SIM communication devices, with, for example, four or more SIMs, such that when one is in use, the others may be deactivated.

Further, a UE that includes a plurality of SIMs and connects to two or more separate mobile networks using two or more separate sets of RF resources is termed a multi-SIM-multi-active (MSMA) communication device. An example MSMA communication device is a dual-SIM-dual-active (DSDA) communication device, which includes two SIM cards/subscriptions, each associated with a separate RAT, where both SIMs may remain active at any given time. In another example, the MSMA device may be a triple-SIM-triple-active (TSTA) communication device, which includes three SIM cards/subscriptions, each associated with a separate RAT, where all three SIMs may remain active at any given time. In other examples, the MSMA communication device may be other suitable multi-SIM communication devices, with, for example, four or more SIMs, such that all SIMs are active at any given time.

In addition, a plurality of modes are enabled by one SIM, such that each mode may correspond to a separate RAT. Such SIM is a multi-mode SIM. A UE may include on or more multi-mode SIMs. The UE may be a MSMS communication device (such as, but not limited to, a DSDS or a TSTS communication device), a MSMA communication device (e.g., a DSDA, TSTA communication device, or the like), or a multi-mode device.

As used herein, UE refers to one of a cellular telephone, smart phone, personal or mobile multi-media player, personal data assistant, laptop computer, personal computers, tablet computer, smart book, palm-top computer, wireless electronic mail receiver, multimedia Internet-enabled cellular telephone, wireless gaming controller, and similar personal electronic device that include one or more SIMs, a programmable processor, memory, and circuitry for connecting to one or more mobile communication networks (simultaneously or sequentially). Various embodiments may be useful in mobile communication devices, such as smart phones, and such devices are referred to in the descriptions of various embodiments. However, the embodiments may be useful in any electronic device, such as a DSDS, a TSTS, a DSDA, a TSTA communication device (or other suitable multi-SIM, multi-mode devices), that may individually maintain one or more subscriptions that utilize one or a plurality of separate set of RF resources.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the UE to establish a communication link for a particular communication service with a particular network, the term “SIM” may also be used herein as a shorthand reference to the communication service associated with and enabled by the information (e.g., in the form of various parameters) stored in a particular SIM as the SIM and the communication network, as well as the services and subscriptions supported by that network, correlate to one another.

Embodiments described herein are directed to improving the paging success rate of one or more RATs when the UE is tuned to another RAT separate from the one or more RATs (e.g., for acquiring the other RAT). In the context where two or more RATs may use a same set of RF resources (e.g., a RF transceiver or the like), such as in a MSMS UE, when the set of RF resources are tuned to a first RAT for acquisition, the set of RF resources may not be available for a second RAT (and other additional RATs). This is because the set of RF resources (which may be the only set of RF resources in the UE) may be configured to only tune to only one RAT at a time (i.e., the set of RF resources may not be configured to allow simultaneous tuning in of a plurality of RATs). Thus, when the acquisition time for the first RAT is excessively long, the second RAT may miss pages (i.e., may have a low paging success rate).

Paging success rate is a factor that gauges the performance of a wireless service network (as supported by a RAT) in connection with a UE. Generally, a successful page occurs when the UE successfully receives a paging request, for example, from a mobile switching center (MSC) located at another node of the network and sends a paging response back to the MSC within a predetermined period of time. In particular, the MSC may initiate the paging process by sending a paging request in response to an incoming call by a third-party (or other suitable triggers), while at the same time, a timer is started. Upon receiving the paging request, the UE may send a paging response in a designated channel to the MSC. In response to receiving the paging response, the MSC stops the timer. The time interval timed by the timer is the paging response time. In other words, a successful page occurs when the paging response time is less than a predetermined tolerance time period, and a unsuccessful page occurs when no paging response is received within the predetermined tolerance time period.

Paging success rate is calculated as paging response received by the MSC within a predetermined period of time divided by the total number of paging requests sent by the MSC within that predetermined period of time. Paging success rate is usually measured over a span of 24 hours (i.e., the predetermined period of time is 24 hours), and the standard paging success rate defining acceptable performance is usually at approximately 92%.

Receiving the paging request, sending the paging response, and other paging operations may require access to the RF resources of the UE. Thus, when the set of RF resources may be unavailable because it is tuned to a first RAT for acquisition, such that the UE could not receive the paging request and/or send the paging response for a second RAT, the particular paging attempt of the second RAT is not successful, and the paging success rate may suffer.

As described, the degradation of paging success rate may occur in MSMS and multi-mode SIM UEs. Various embodiments may also apply to UEs with multiple sets of RF resources (such as in the case of MSMA UEs as described), where the set of RF resources designated for the second RAT may be unavailable for the second RAT, and the second RAT may require the set of RF resources designated for the first RAT, while the first RAT is being acquired.

Accordingly, various embodiments may break up acquisition process of the first RAT (e.g., WCDMA) into multiple “chunks,” and allow the second RAT (e.g., GSM) to receive/send pages at one or more preemption points, which may be points in time between the chunks. Thus, a higher paging success rate of the second RAT may be achieved, given that the second RAT may obtain an opportunity to use the set of RF resources without waiting until the acquisition of the first RAT is completed. In addition, safeguards are placed to prevent the acquisition samples from becoming “stale.”

As used herein, a “chunk” may refer to a portion of the code or process for a RAT acquisition process (or other processes which may use the RF resources of the UE), the acquisition process being a process for acquiring various communication protocols of the RAT in order to acquire and establish communication or traffic with the target base node that is broadcasting the RAT. In some embodiments, the acquisition process may be defined selectively (e.g., segmented) into two or more chunks based on criteria described herein, where the acquisition process may be a continuous process with no breaks. The acquisition process may also include one or more breaks not defined by the split acquisition processes and systems described herein, where the segmenting of the acquisition process into chunks may define additional breaks.

As used herein, a “phase” of the acquisition process of a RAT may include one or more distinct processes that achieve a purpose and/or yield a particular set of data, where such set of data may not be obtained if the phase has not completed. Such data may be used for further computation or processing by another phase that follows the phase yielding the data (i.e., one phase may set up computational premise or data for another phase).

A phase may further include one or more “stages,” where each stage may represent one or more distinct processes that achieve a purpose or yield a particular type of data, where the particular set of data may not be obtained if the stage is not completed. Such data may be used for further computation or processing by another stage that follows the phase yielding the data (i.e., one phase may set up computational premise or data for another phase). In general, phases and stages may be used herein to describe two different levels of abstraction, where a phase may be a higher level of abstraction than a stage, where the acquisition process may include one or more phases, and each phase may include one or more stages.

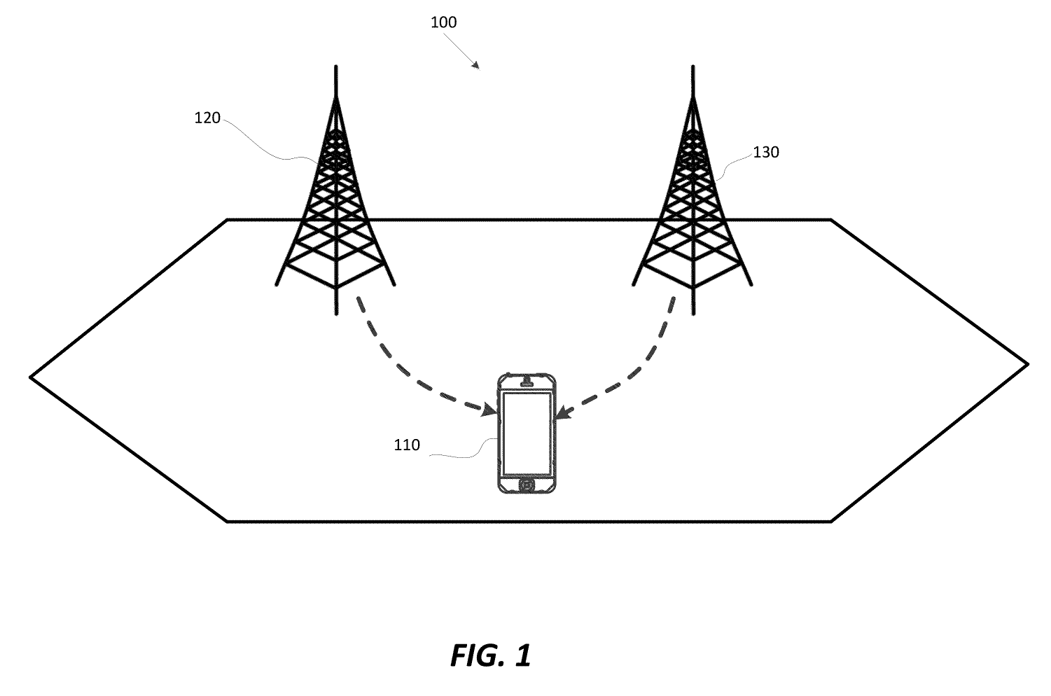

With reference to FIG. 1, a schematic diagram of a system 100 is shown in accordance with various embodiments. The system 100 may include a UE 110, a first base station 120, and a second base station 130. In some embodiments, each of the first base station 120 and the second base station 130 may represent a separate RAT, such as GSM, CDMA, CDMA2000, TDCDMA, TDSCDMA, WCDMA, TDMA, FDMA, LTE, VoLTE, SGLTE, SVLTE, and/or the like. In other words, the first base station 120 may represent a first RAT, and the second base station may represent a second RAT, where the first RAT and the second RAT are different RATs. By way of illustrating with a non-limiting example, the first base station 120 may be transmitting WCDMA while the second base station 130 may be transmitting GSM. In some embodiments, each RAT may be transmitted by the associated base station at different physical locations (i.e., the first base station 120 and the second base station 130 may be at different locations). In other embodiments, each RAT may be transmitted by the associated base station at the same physical location (i.e., the first base station 120 and the second base station 130 may be physically joined, or the base stations are the same base station).

The first base station 120 and the second base station 130 may each include at least one antenna group or transmission station located in the same or different areas, where the at least one antenna group or transmission station may be associated with signal transmission and reception. The first base station 120 and the second base station 130 may each include one or more processors, modulators, multiplexers, demodulators, demultiplexers, antennas, and the like for performing the functions described herein. In some embodiments, the first base station 120 and the second base station 130 may be utilized for communication with the UE 110 and may be an access point, Node B, evolved Node B (eNode B or eNB), base transceiver station (BTS), or the like.

In various embodiments, the UE 110 may be configured to access the RATs from the first base station 120 and/or the second base station 130 (e.g., receive/transmit signals of the first and/or the second RAT from/to the first base station 120 and/or the second base station 130). The UE 110 may be configured to access the RATs by virtue of the multi-SIM and/or the multi-mode SIM configuration of the UE as described, such that when a SIM corresponding to a RAT is received, the UE 110 may be allowed to access that RAT, as provided by the associated base station.

In general, an acquisition process of a RAT refers to the process in which the UE 110 searches and acquires various communication protocols of the RAT in order to acquire and establish communication or traffic with the target base node that is broadcasting the RAT. Some communication protocol include synchronization channels, such as, but not limited to, primary synchronization channel (P-SCH), secondary synchronization channel (S-SCH), common pilot channel (CPICH), and the like. The target base node are nodes that transmit, broadcast, or otherwise support the particular RAT being acquired. As shown in FIG. 1, the first base station 120 may be a target base node for the first RAT, given that the first RAT may be transmitted by the first base station 120 as described. Thus, when the UE 110 initiates an acquisition process of the first RAT (as supported by the first base station 120), a communication channel is set for future communication and traffic between the UE 110 and the first base station 120. Similarly, the second base station 130 may be a target base node for the second RAT, which is transmitted by the second base station 130 as described. Thus, when the UE 110 initiates an acquisition process of the second RAT, a communication channel is set for future communication and traffic between the UE 110 and the second base station 130. The acquisition process may be initiated when the UE 110 seeks to initially access the RAT, or, after attaching to an initial RAT, to identify candidate target RAT (that is not the initial RAT) for a handover.

It should be appreciated by one of ordinary skill in the art that FIG. 1 and its corresponding disclosure are for illustrative purposes, and that the system 100 may include three or more base stations. In some embodiments, three or more base stations may be present, where each of the three or more base stations may represent (i.e., transmits signals for) one or more separate RATs in the manner such as, but not limited to, described herein.

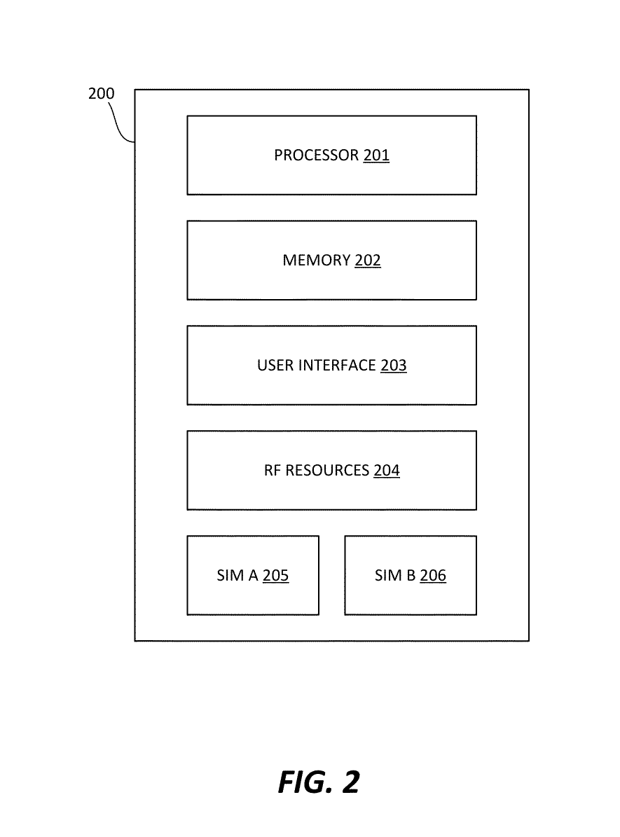

FIG. 2 is a functional block diagram of an UE 200 suitable for implementing various embodiments. According to various embodiments, the UE 200 may be the same or similar to the UE 110 as described with reference to FIG. 1. With reference to FIGS. 1-2, the UE 200 may include at least one processor 201, memory 202 coupled to the processor 201, a user interface 203, one or more SIMs (as denoted SIM A 205 and SIM B 206).

The processor 201 may include any suitable data processing device, such as a general-purpose processor (e.g., a microprocessor), but in the alternative, the processor 201 may be any suitable electronic processor, controller, microcontroller, or state machine. The processor 201 may also be implemented as a combination of computing devices (e.g., a combination of a DSP and a microprocessor, a plurality of microprocessors, at least one microprocessors in conjunction with a DSP core, or any other such configuration). The memory 202 may be operatively coupled to the processor 201 and may include any suitable internal or external device for storing software and data for controlling and use by the processor 201 to perform operations and functions described herein, including, but not limited to, random access memory RAM, read only memory ROM, floppy disks, hard disks, dongles or other USB connected memory devices, or the like. The memory 202 may store an operating system (OS), as well as user application software and executable instructions. The memory 202 may also store application data, such as an array data structure.

The user interface 203 may include a display and a user input device. In some embodiments, the display may include any suitable device that provides a human-perceptible visible signal, audible signal, tactile signal, or any combination thereof, including, but not limited to a touchscreen, LCD, LED, CRT, plasma, or other suitable display screen, audio speaker or other audio generating device, combinations thereof, and the like. In various embodiments, the user input device may include any suitable device that receives input from the use, the user input device including, but not limited to one or more manual operator (such as, but not limited to a switch, button, touchscreen, knob, slider or the like), microphone, camera, image sensor, and the like.

The processor 201 and the memory 202 may be coupled to the RF resources 204. In some embodiments, the RF resources 204 may be one set of RF resources such that only one RAT may be supported by the set of RF resources at any given time. In other embodiments, the RF sources may be a plurality of sets of RF resources, such that each set may support one RAT at a given time, thus enabling the UE 200 to support multiple RATs simultaneously such as but not limited to, in a MSMA case. The RF resources 204 may include at least one baseband-RF resource chain, with which each SIM in the UE 200 (e.g., the SIM A 205 and the SIM B 206) may be associated. The baseband-RF resource chain may include a baseband modem processor, which may perform baseband/modem functions for communications on at least one SIM, and may include one or more amplifiers and radios. In some embodiments, baseband-RF resource chains may share the baseband modem processor (i.e., a single device that performs baseband/modem functions for all SIMs on the UE 200). In other embodiments, each baseband-RF resource chain may include physically or logically separate baseband processors.

The RF resources 204 may include transceivers that perform transmit/receive functions for the associated SIM of the UE 200. The RF resources 204 may include separate transmit and receive circuitry, or may include a transceiver that combines transmitter and receiver functions. The RF resources 204 may each be coupled to a wireless antenna.

In some embodiments, the processor 201, the memory 202, and the RF resources 204 may be included in the UE 200 as a system-on-chip. In some embodiments, the one or more SIMs (e.g., SIM A 205 and SIM B 206) and their corresponding interfaces may be external to the system-on-chip. Further, various input and output devices may be coupled to components on the system-on-chip, such as interfaces or controllers.

The UE 110 is configured to receive one or more SIMs (e.g., SIM A 205 and SIM B 206), an example of which is described herein. A SIM in various embodiments may be a Universal Integrated Circuit Card (UICC) that is configured with SIM and/or USIM applications, enabling access to various RAT networks as described. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the UE 200, and thus need not be a separate or removable circuit, chip or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

In some embodiments, the UE 200 may include a first SIM interface (not shown), which may receive a first SIM (e.g., SIM A 205, which may be associated with one or more RATs). In addition, the UE 200 may also include a second SIM interface (not shown), which may receive a second SIM (e.g., SIM B 206, which may be associated with one or more RATs that may be different or the same in some cases than the one or more RATs associated with SIM A 205). Each SIM may enable a plurality of RATs by being configured as a multi-mode SIM, as described herein. In some embodiments, a first RAT enabled may be a same or different RAT as a second RAT (e.g., a DSDS device may enable two RATs, where both of them may be GSM, or one of them may be GSM and the other may be WCDMA). In addition, two RATs (which may be the same or different) may each be associated with a separate subscription, or both of them may be associated with a same subscription. For example, a DSDS device may enable LTE and GSM, where both of the RATs enabled may be associated with a same subscription, or, in other cases, LTE may be associated with a first subscription and GSM may be associated with a second subscription different from the first subscription.

In embodiments in which the UE 200 comprises a smart phone or other mobile phone device, the UE 200 may have existing hardware and software for telephone and other typical wireless telephone operations, as well as additional hardware and software for providing functions as described herein. Such existing hardware and software includes, for example, one or more input devices (such as, but not limited to keyboards, buttons, touchscreens, cameras, microphones, environmental parameter or condition sensors), display devices (such as, but not limited to electronic display screens, lamps or other light emitting devices, speakers or other audio output devices), telephone and other network communication electronics and software, processing electronics, electronic storage devices and one or more antennae and receiving electronics for receiving various RATs. In such embodiments, some of that existing electronics hardware and software may also be used in the systems and processes for functions as described herein.

Accordingly, such embodiments can be implemented with minimal additional hardware costs. However, other embodiments relate to systems and process that are implemented with dedicated device hardware (UE 200) specifically configured for performing operations described herein. Hardware and/or software for the functions may be incorporated in the UE 200 during manufacturing, for example, as part of the original equipment manufacturer's configuration of the UE 200. In further embodiments, such hardware and/or software may be added to the UE 200, after manufacturing of the UE 200, such as by, but not limited to, installing one or more software applications onto the UE 200.

In some embodiments, the UE 200 may include, among other things, additional SIM(s), SIM interface(s), additional RF resource(s) (i.e., sets of RF resources) associated with the additional SIM(s), and additional antennae for connecting to additional RATs supported by the additional SIMs.

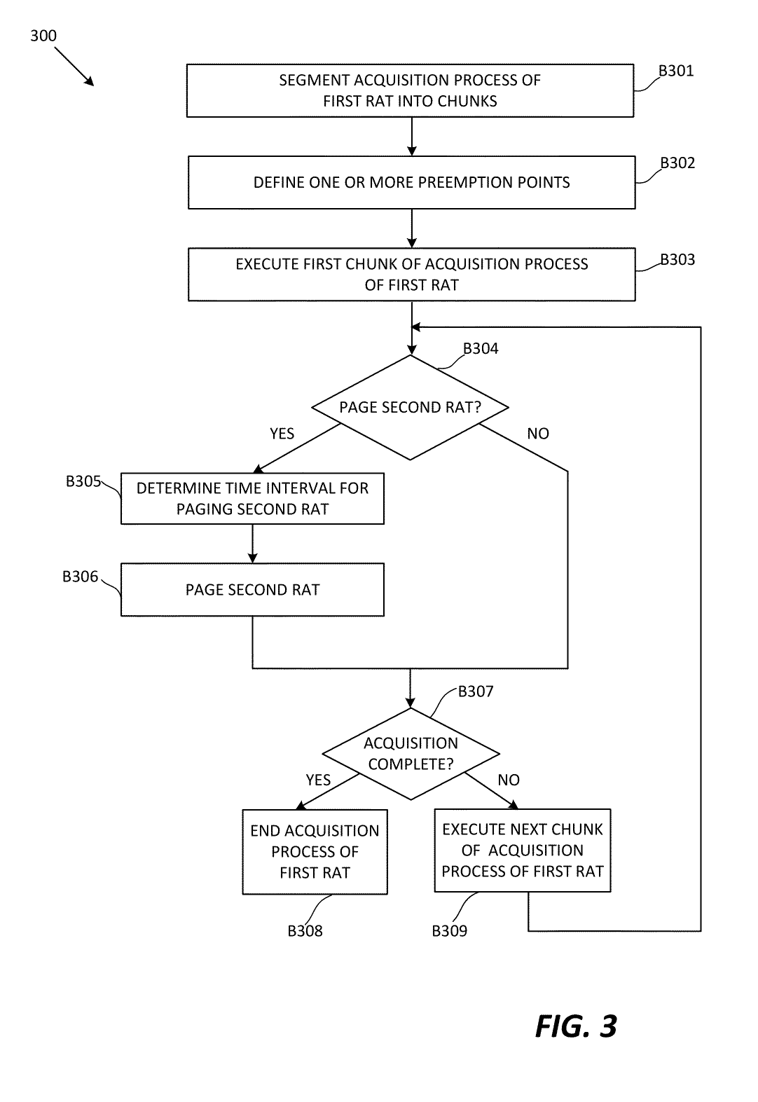

A process flowchart of a split acquisition process 300 carried out by the UE 110 (or UE 200 as depicted in FIG. 2) according to various embodiments is illustrated in FIG. 3. With reference to FIGS. 1-3, at block B301, the acquisition process of a first RAT is segmented, split, or otherwise divided into two or more units referred to as “chunks” (e.g., by the processor 201 of the UE 200). The RAT acquisition process refers to a process in which the UE 110 searches and acquires various communication protocols of the RAT in order to acquire and establish communication or traffic with the target base node that is broadcasting the RAT, as described.

While different RATs may be associated with acquisition processes that may differ in one or more aspects, RAT acquisition processes may generally be characterized as including one or more separate phases such as, but not limited to, a synchronization or cell search phase, frequency pull-in phase, system information decoding phase, system information reading phase, random access procedure phase, and the like. Each phase of the RAT acquisition process may represent a distinct process or groups of processes that achieve a purpose or yield a particular set of data, where the particular set of data may not be obtained if the phase has not completed. Such data may be used for further computation or processing by another phase that follows the phase yielding the data. For example, the synchronization phase may establish time synchronization with the data channels broadcasted by the base station (and, in some cases, obtain a scrambling code that identifies the base station), and yields a set of data that identifies the base station. The frequency pull-in phase seeks to pull in (or otherwise acquire) the frequency associated with the RAT being broadcasted by the base station. The system information decoding phase may obtain data transmitted by the base station and decode such data (i.e., set up for the data reading phase). At the system information reading phase, the UE 200 may read or otherwise process the information transmitted by the base station for network parameters. At the random access procedure phase, the UE 200 may utilize random access practices to establish connection with the node.

In some embodiments, the phases may proceed in a sequential order, such that when one phase is finished, another phase follows. In other words, the acquisition process of the RAT is continuous with respect to time. For example, the order of operation for one example of the acquisition process may be first the synchronization or cell search phase, next the frequency pull-in phase, then the system information decoding phase, next system information reading phase, and lastly the random access procedure phase. In other embodiments, two or more of the phase described above may proceeding in parallel (e.g., through two sets of RF resources as described herein, or through a same set of RF resources that may support simultaneously running two or more acquisition phases).

In addition, each phase may include one or more stages, such that each stage may represent a distinct operation or process within a phase (i.e., one or more stages may make up a phase as described). In some particular embodiments, a synchronization or cell search phase may include a slot timing determination stage, a frame timing determination stage, and a code sequence search stage; a frequency pull-in phase may include a single frequency pull-in stage; a system information decoding phase may include a search result listing stage, a triaging stage, a primary common control physical channel (PCCPCH) set up stage, a transmission time interval determination stage, and a master information block (MIB) reading stage; a system information block (SIB) reading phase may include a SIB reading stage; and a random access procedure phase may include other stages in the acquisition process.

Each stage making up a phase of the RAT acquisition process may represent a distinct process or groups of processes that achieve a purpose or yield a particular type of data, further computation or processing may not be obtained if the stage is not completed. Such data may be used for further computation or processing by another stage that follows the stage yielding the data.

In some embodiments, the stages may proceed in a sequential order, such that when one stage of a phase is finished, another stage of the same (or different) phase may follow. For example, the order of operation for one example of the acquisition process may be first the slot timing determination stage, then the frame timing determination stage, and the code sequence search stage, next the frequency pull-in stage, next the search result listing stage, then the triaging stage, next the PCCPCH set up stage, and the transmission time interval determination stage, next the master information block reading stage, then the system information block reading stage, and other stages in the acquisition process. In other embodiments, two or more of the stages described above may proceeding in parallel (e.g., through two sets of RF resources as described herein, or through a same set of RF resources that may support simultaneously running two or more acquisition stages).

It should be appreciated by one of ordinary skills in the art that the phases and stages are used herein to describe and define the acquisition process of a RAT, and the RAT acquisition process (for example, the scope of the RAT acquisition process) is not limited to what is described. For example, a stage may be defined as a part of one particular phase in some embodiments, but a part of another phase in other embodiments. Two or more stages may be defined as a single stage. In another example, one stage may be included in one phase (or a chunk), and the same stage may be included again in another phase (or chunk).

Segmenting the acquisition process of the first RAT into chunks may include defining the chunks. As described, a chunk may include one or more phases, such that the chunk may be defined by which phase(s) the chunk includes. Each of the one or more phases, in turn, may include the stages associated with that phase. In one example, a first chunk may include a first phase, a second chunk may include a second phase, and a third chunk may include a third phase. In some embodiments, a chunk may be defined by the stages that the chunk includes. For example, a first chunk may include stages A-C, a second chunk may include stage D, a third chunk may include stages E-I, and a fourth chunk may include stage J, where stages A-J may be stages of the acquisition process.

Therefore, the RAT acquisition process may be segmented based on the phases and/or stages of the RAT acquisition process, such that a break may be set at the end of one or more phases or stages (i.e., the end of one chunk), and before the start of the next phase or stage (the beginning of another chunk) during the RAT acquisition process. In some embodiments, a chunk may represent one or more phases or stages, where no break is set during the execution of the chunk, and a break may be set before and/or after the chunk. In other words, a break may be set between two chunks that are adjacent during execution time.

In some embodiments, the chunks (and the breaks) may be defined (i.e., the phases and stages of the acquisition process of the first RAT is segmented into chunks as described) before the acquisition process, by a user of the UE 200 (through the user interface 203), the original equipment manufacturer through factory settings, and/or other suitable personnel through any suitable means. In particular embodiments, the chunks may be predefined before the initialization of the UE 200 for use (i.e., before an out-of-the-box-experience of the UE 200). In some embodiments the chunks may be defined after the initialization of the UE 200 and before the acquisition process is executed, by the UE 200 automatically according to algorithm stored on the memory 202 and executed by the processor 201 of the UE 200, or by the user through the user interface 203 of the UE 200. In other embodiments, chunks may be defined after the acquisition process is started (e.g., in real-time, automatically by the UE 200 according to algorithm stored on the memory 202 and executed by the processor 201 of the UE 200, or by the user through the user interface 203 of the UE 200).

By segmenting the acquisition process of the first RAT based on phases or stages, the methods and apparatus described herein allow the acquisition process to arrive at a natural break first (e.g., completing one or a group of processes and/or obtaining data values to be used in the acquisition process) before tuning away from the first RAT to execute a paging process (or at least a portion thereof) for paging the second RAT. Accordingly, the acquisition process is being segmented such that the acquisition process may be completed efficiently, given that if a phase or a stage may be interrupted in the middle of operations, the same phase or stage may be required to be restarted after the UE 200 configures the RF resources 204 to be tuned back into the first RAT after tuning to the second RAT for paging the second RAT. This is because certain types of data may not be obtained if the phases or stages are interrupted before the phases or stages are allowed to obtain the data. Restarting a particular phase or stage may waste time, as a portion of the phase or stage has already been executed before paging the second RAT and no useful data value has been obtained.

In some embodiments, the phases and the stages of the acquisition process may be grouped into chunks based on time, such that the chunks may include one or more phases or stages of the acquisition process, and that time is taken into consideration when grouping the one or more phases or stages into a chunk. Each phase or stage of the acquisition process may be associated with an effective execution time, which is a period of time measured from the beginning of the particular phase or stage to the end of that phase or stage. Thus, each chunk, which is made up by one or more phases or stages, may also be associated with an effective execution time. In some embodiments, the chunks may be segmented such that each chunk may be associated with a same effective execution time. Such execution time may be, for example, 50 ms, 80 ms, 100 ms, 150 ms, 200 ms, 300 ms, and other suitable time. The processor 201 of the UE 200 may determine the execution time, such as, but not limited to, accessing the memory 202 which may store suitable execution times. In further embodiments, the effective execution time of a chunk may be set based on paging time or paging interval of the second RAT. For example, when the processor 201 of the UE 200 determines that the paging process for paging the second RAT may be executed at least once every 80 ms, then the acquisition process of the first RAT may be segmented such that each chunk may be associated with a 80 ms (or less) effective execution time; thus, at the end of the chunk, the RF resources 240 of the UE 200 may be tuned to the second RAT for paging processes. Therefore, such segmentation of the acquisition process reduces the page missing rate for the second RAT by breaking the acquisition process of the first RAT at the appropriate time for receiving pages of the second RAT.

In some embodiments, the acquisition process may be segmented such that each chunk may be associated with an effective execution time that is within a predetermined interval of time. Given that each phase or stage represent different processes or groups of processes within the acquisition process, it may be difficult to group the stages into chunks of exact (or near exact) effective execution time. Accordingly, grouping the phases and the stages into chunks based on an predetermined interval can allow improved flexibility in segmenting the acquisition process. Examples of the predetermined interval of time include, but not limited to, 30-60 ms, 60-100 ms, 70-130 ms, 80-120 ms, 120-180 ms, 150-250 ms, 240-360 ms, and other suitable time intervals. In some non-limiting examples, where the predetermined time interval may be 60-100 ms, the acquisition process may be segmented such that a first chunk (including its corresponding phases and/or stages) may be associated with an effective execution time of 80 ms, a second chunk may be associated with an effective execution time of 95 ms, a third chunk may be associated with an effective execution time of 65 ms, and a fourth chunk may be associated with an effective execution time of 70 ms. The predetermined time interval for the effective execution time of each chunk may be set based on paging time or paging interval of the second RAT. For example, if the processor 201 of the UE 200 determines that the paging process for paging the second RAT may be executed once every 80 ms, then the acquisition may be segmented such that each chunk may be associated with a 80 ms effective execution time; thus, at the end of the chunk, the RF resources 240 of the UE 200 may be tuned to the second RAT for paging processes. Accordingly, in some embodiments the acquisition process may be grouped based on both the phases/stages of the acquisition process and time.

In other embodiments, the acquisition process may be segmented based on time, such that a chunk may run for a predefined effective execution time, and ends when the predefined effective execution time has lapsed, irrespective of the phase/stage that the acquisition process is in. In other words, a predetermined time period is set, such that the acquisition process is segmented into chunks with effective execution time of the predetermined time period even when the phases or stages cannot be completed within the predetermined time period. Such embodiments may be advantageous when it is determined that the UE 200 may adhere strictly to the paging requirements of the second RAT, such that the UE 200 may be configured to execute a paging process for paging the second RAT at regular time intervals. Thus, the UE 200 may first determine a priority between paging the second RAT or acquiring the first RAT, and when it is determined that paging the second RAT is a higher priority than acquiring the first RAT, then the UE 200 may, as described, segmented the acquisition process into chunks with effective execution time of the predetermined time period even when the phases or stages cannot be completed within the predetermined time period. In some embodiments, the predetermined time period may be the same for every chunk to, for example, correspond to a period paging scheme for the second RAT. In other embodiments, the predetermined time period may be different for two or more chunks to, for example, correspond any other types of suitable paging scheme.

Next at block B302, one or more preemption points is defined between the chunks (e.g., by the processor 201 of the UE 200). The preemption point(s) may designate when the second RAT may be paged (i.e., the preemption points may correspond to the breaks in the chunks as described). In some embodiments, the preemptions points may be between two chunks. In further embodiments, the preemptions points may also be before an initial chunk of the acquisition process and/or after the end chunk of the acquisition process. The preemption points may be set in response to the segmenting (and/or) of the chunks. In some embodiments, the preemption points may be defined before the acquisition process is executed, by a user of the UE 200 (through the user interface 203), the original equipment manufacturer through factory settings, and/or other suitable personnel through any suitable means. In particular embodiments, the preemption points may be predefined before the initialization of the UE 200 for use (i.e., before out-of-the-box-experience of the UE 200). In some embodiments the preemption points may be defined after the initialization of the UE 200 and before the acquisition process is executed, by the UE 200 automatically according to algorithm stored on the memory 202 and executed by the processor 201 of the UE 200, or by the user through the user interface 203 of the UE 200. In other embodiments, preemption points may be defined after the acquisition process is started (e.g., in real-time, automatically by the UE 200 according to algorithm stored on the memory 202 and executed by the processor 201 of the UE 200, or by the user through the user interface 203 of the UE 200).

Next at block B303, a first chunk of the acquisition process of the first RAT may be executed by (e.g., the processor 201 of the UE 200). As used herein, a first chunk may be defined as the first chunk of the acquisition process, or a chunk that is prior in time than a next chunk.

Next at block B304, the processor 201 may determine whether to execute a process for paging the second RAT, the paging process including tuning away from the first RAT and tuning in to the second RAT. Such determination may be made by the user of the UE 200 through the user interface 203 of the UE 200, or by the UE 200 automatically according to algorithms stored on the memory 202 and executed by the processor 201 of the UE 200. In some embodiments, the UE 200 may always be configured to execute the second RAT paging process at the preemption points between the chunks (i.e., the processor 201 of the UE 200 may always execute the paging process for paging the second RAT, and the outcome of block B304 is always YES such that block B304 may be omitted). In other embodiments, the UE 200 may be configured to determine whether to execute the second RAT paging process before executing the second RAT paging process.

In some embodiments, the UE 200 may be configured to check for an outstanding paging request to the UE 200 by tuning to the second RAT for a brief period of time and “listening” for a paging message for a predetermined period of time (e.g., 5 ms, 10 ms, or 15 ms). In further or alternative embodiments, the UE 200 may check its memory (e.g., the memory 202 of the UE 200) whether the UE 200 had already received a paging request and a paging response is required to be sent by the UE 200 to complete the paging of the second RAT. When an outstanding paging request to the UE 200 is found and/or when there is an outstanding paging response that is required to be sent by the UE 200, the UE 200 may determine that the paging process for paging the second RAT is required to be executed. The UE 200 may be configured to determine whether to execute a paging process for paging the second RAT in response to of the first chunk being completely executed, or in response to the first chunk yielding a particular set of data as described.

In various embodiments, the paging process for paging the second RAT may include the listening for the paging message or request, receiving the page, decoding or otherwise processing the page, transmitting response, and the like. As such, a part of the paging process may be performed between the chunks (e.g., at the preemption point, or the entire paging process may be performed). In some embodiments, the UE 200 may be configured to receive pages or paging requests at the preemption points only. In other embodiments, other processes included or related to the paging process may be performed at the preemption point. Portions of paging processes not completed and/or not initiated at a first preemption point may be continued or initiated at a subsequent preemption point, where a predetermined amount of time may be allocated at each preemption point. The paging process performed by the UE 200 may be referred to herein as performing or executing “a paging process,” “paging a second (or additional) RAT,” and the like.

When it has been determined that the paging process for paging the second RAT is to be executed (e.g., by the processor 201), then next at block B305 (B304:YES), a time interval is determined for paging the second RAT. In some embodiments, the process for paging the second RAT proceeds without determining the time interval for paging the second RAT (i.e., no meaningful time restriction is placed on the paging process). For example, the paging process for paging the second RAT may be including a paging process for a number of frames (the number of frames being 1 to N), where each frame may be associated with a frame decoding time. In other words, the second RAT may use the RF resources 204 for N multiplied by the frame decoding time of each frame. The UE 200 (e.g., processor 201) may be configured to determine (through the user interface 203 of the UE 200) the number frames to be executed (the number being equal or greater than 1, or equal or less than N) based on various environmental factors, such as, but not limited to, signal condition (e.g., signal strength), background noise, and the like. For instance, the signal condition may be inversely proportional to the number of frames to be executed (i.e., a lesser number of frames may be executed when the signal condition is determined to be relatively good, as compared to when the signal condition is determined to be relatively bad, the UE 200 may determine to execute a paging process for a greater number of frames). As such, given that the environmental factors may change over time, the number of pages to be executed at each preemption point may differ. In particular embodiments, a plurality of levels of signal conditions may be defined, where each level may be associated with a frame number to be executed. When the signal condition at the time of second RAT paging falls within one of the predetermined levels, the paging process for paging the second RAT is executed for the corresponding number of frames.

In other embodiments, a paging time interval is determined before the execution of the second RAT paging, such that the RF resources 204 may be tuned away from the second RAT to the first RAT for acquiring the first RAT (executing the next chunk) at the end of the time interval. In particular embodiments, the paging time interval may correspond to a predetermined number of pages to be executed at each preemption point (where the number of pages to be executed may be the same number of different for two or more preemption points based on suitable factors). The number of pages to be executed may be based on signal condition at various point in time before the second RAT is to be executed, or when the second RAT is to be executed.

Next at block B306, the second RAT may be executed by allowing the UE 200 to configure the RF resources 204 to tune to the second RAT and perform the paging process as described. In particular, the UE 200 may receive a paging request from the MSC (with the RF resources 204) or the like. The UE 200 may be configured to decode or otherwise process the paging request (with the processor 201) and send a paging response back to the MSC (with the RF resources 204) within the paging response time. As described, the UE 200 may be configured to decode the paging request for a number of frames.

Next at block B307, it is determined (e.g., by the processor 201) whether the acquisition process of the first RAT has been completed. Such determination may be made in response to the completion of paging the second RAT, or, in response to the determination that the paging process for paging second RAT is not to be executed (B304:NO). The UE 200 may be configured to check whether there is another chunk (after the first chunk) to be executed (e.g., by checking a chunk index value that is associated with the particular chunk, the chunk index value may indicate the chunk's position in the acquisition process). Alternatively, the UE 200 may check whether the first chunk (e.g., the chunk executed before the paging process for paging the second RAT is executed) is the last chunk of the acquisition process.

When it is determined that the acquisition process of the first RAT is completed, then next at block B308 (B307:YES), the acquisition of the first RAT may end (i.e., the first RAT may have been acquired, and the UE 200 may be camped on the first RAT). The RAT may now acquire data and services from the base station (e.g., 120) associated with the first RAT.

On the other hand, when it is determined that the acquisition process is not completed, next at block B309 (B307:NO), a next chunk of the acquisition process of the first RAT may be executed by (e.g., the processor 201 of the UE 200). As used herein, the next chunk may be defined as a chunk of the acquisition process after the first chunk (e.g., a second chunk). Then, in response to the completion of executing the next chunk of the acquisition process at block B309, the determination is made at block B304 as to whether to execute a paging process for paging the second RAT. The split acquisition process 300 then proceeds according to what is described following block B304.

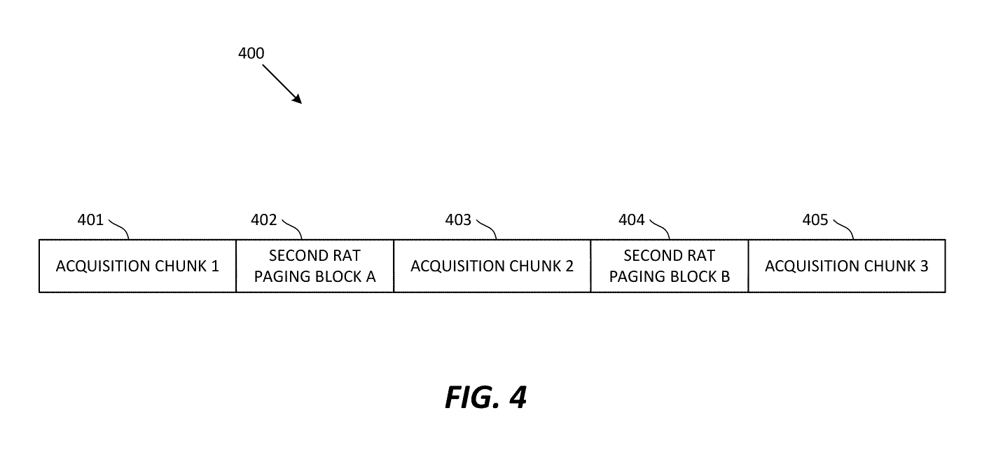

Now referring to FIGS. 1-4, FIG. 4 is a block diagram illustrating an example of a split acquisition process 400 according to various embodiments. The acquisition process of the first RAT may include acquisition chunk 1 401, acquisition chunk 2 403, and acquisition chunk 3 405. The acquisition process has been segmented into three acquisition chunks 401, 403, 405 in the manner described, such that each chunk may include one or more phases (and the corresponding stages within each of the phases) or one or more stages (when the acquisition process is segmented based on stages, not phases). The execution time of the acquisition chunks 401, 403, 405 may be the same or different, depending on the particular phases or stages included in each chunk, and/or whether a time interval is specified for the acquisition chunks 401, 403, 405.

The paging processes blocks 402, 404 of the second RAT may be inserted or otherwise defined between two acquisition chunks that are adjacent in time (e.g., at the preemption points as described). For example, the second RAT paging block A 402 may take place after the acquisition chunk 1 401 and before acquisition chunk 2 403, and the second RAT paging block B 404 may take place after the acquisition chunk 2 403 and before the acquisition chunk 3 405. In some embodiments, the second RAT paging block A 403 may be initiated in response to the completion of the acquisition chunk 1 401; the acquisition chunk 2 403 may be initiated in response to the completion of the second RAT paging block A 402; the second RAT paging block B 404 may be initiated in response to the completion of the acquisition chunk 2 403; the acquisition chunk 3 405 may be initiated in response to the completion of the second RAT paging block B 404.

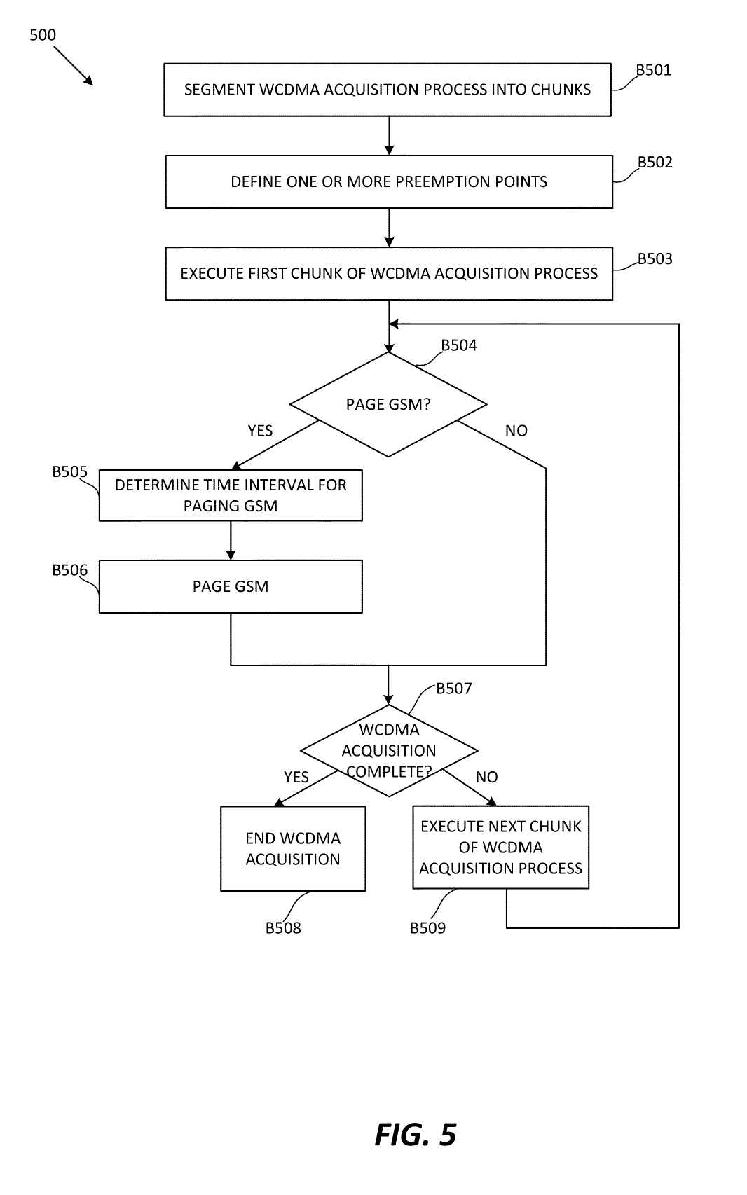

A process flowchart of a WCDMA split acquisition process 500 coupled with GSM paging and carried out by the UE 110 (or UE 200 as depicted in FIG. 2) is illustrated in FIG. 5 according to various embodiments. The split acquisition process of WCDMA 500 may be a specific implementation of the split acquisition process illustrated in FIG. 3. With reference to FIGS. 1-5, at block B501, the acquisition process of WCDMA is segmented, split, or otherwise divided into two or more chunks (e.g., by the processor 201 of the UE 200). The WCDMA acquisition process refers to a process in which the UE 200 searches and acquires various communication protocols of WCDMA in order to acquire and establish communication or traffic with the target base node that is broadcasting WCDMA. In some embodiments, a set of coherent data may be obtained at the end of the chunk, such that any temporal interruption within the chunk may result in restarting the process defined in the chunk.

The WCDMA acquisition process may be characterized as including one or more separate phases such as, but not limited to, a synchronization or cell search phase, frequency pull-in phase, system information decoding phase, system information reading phase, random access procedure phase, and the like. The synchronization phase may establish synchronization with the data channels broadcasted by the base station (and, in some cases, obtain a scrambling code that identifies the base station), and yields a set of data that identifies the base station. The frequency pull-in phase seeks to pull in (or otherwise acquire) the frequency associated with WCDMA being broadcasted by the base station. The system information decoding phase may obtain data transmitted by the base station and decode such data (i.e., setting up for the data reading phase). At the system information reading phase, the UE 200 reads or otherwise processes the information transmitted by the base station. At the random access procedure phase, the UE 200 may use random access practices to establish connection with the node.

In addition, each phase of the WCDMA acquisition phase may include one or more stages, such that each stage may represent a distinct operation or process within a phase (i.e., one or more stages may make up a phase as described). In one nonlimiting example, a synchronization or cell search phase may include a slot timing determination stage, a frame timing determination stage, and a code sequence search stage; a frequency pull-in phase may include a single frequency pull-in stage; a system information decoding phase may include a search result listing stage, a triaging stage, a PCCPCH set up stage, a transmission time interval determination stage, and a master information block reading stage; a system information reading phase may include a system information block reading stage; and a random access procedure phase may include other stages in the acquisition process.

In particular embodiments, the WCDMA acquisition process may be segmented such that a first chunk may include the synchronization phase, a second chunk may include the frequency pull-in phase, a third chunk may include the system information decoding phase, and a fourth chunk may include a system information reading phase. In other words, the WCDMA acquisition process may include multiple stages such as 1) determining the slot timing, 2) determining the frame timing, 3) searching PN sequence, 4) pulling in frequency, 5) listing search results, 6) triaging, 7) setting up PCCPCH, 8) transmitting time interval determination, 9) MIB reading, and 10) SIB reading, where stages 1-3 (the synchronization phase) may be in a first chunk, stage 4 (frequency pull-in phase) may be in a second chunk, stages 5-9 (system information decoding phase) may be in a third chunk, and stage 10 (system information reading phase) may be in a fourth chunk.

In other embodiments, a chunk may contain other suitable combinations of stages or phases. In particular embodiments, the chunks may be defined based on stages of the WCDMA acquisition. For example, determining the slot timing, determining the frame timing, searching PN sequence, and pulling in frequency may be defined in a first chunk; listing search results, triaging, setting up PCCPCH, and transmitting time interval determination may be defined in a second chunk; and MIB reading and SIB reading may be defined as a third chunk. In another example, determining the slot timing, determining the frame timing, searching PN sequence may be defined as a first chunk; pulling in frequency, listing search results, and triaging may be defined as a second chunk; setting up PCCPCH, transmitting time interval determination, and MIB reading may be defined in a third chunk; and SIB reading may be defined as a fourth chunk. Defining chunks based on stages may have the same outcome as defining chunks based on phase, or may have different outcomes that result a finer division of the WCDMA acquisition process.

WCDMA data channels are partitioned into slots and frames, where a slot may be 666.67 μs, which is equivalent to 2560 chips of the system chip rate. In some cases, 15 slots are linked or otherwise grouped together to form a frame, which is 10 ms long. The UE 200 (e.g., processor 201) may use a primary synchronization code (PSC) to acquire slot synchronization to a base station (e.g., with a single filter matched to the PSC). Thus, slot timing can be obtained by detecting peak values in the matched filter output. Multiple slots may be monitored to determine a slot boundary with confidence. Accordingly, the UE 200 may receive the PSC from a plurality of base stations, and will select the PSC with basic unit of time. the strongest signal.

The UE 200 may use a secondary synchronization code (SSC) to synchronize frames and to identify a code of the base station (e.g., 120, 130). The UE 200 may determine the frame timing by correlating the received SSC with all known SSC.

The PN sequence search, which is also known as a scrambling code identification, identifies a scrambling code that identifies the base station. The UE 200 may be configured to search for the identity of the base station (e.g., based on a pseudo-noise code identifier).

A frequency pull-in stage is a stage in which the UE 200 (e.g., the processor 201) determines at least one reliable base station among the base stations detected or identified. An identified base station may be determined to be reliable when a path between the UE 220 and the base station has the least number of frequency errors and/or is associated with a signal energy that is higher than a predetermined energy threshold. In the PCCPCH set up stage, a channel by which the UE 200 may decode WCDMA protocols (i.e., the PCCPCH, may be set up). In the transmission time interval determination stage, the time interval for transmission of a transport block from the base station is determined. In MIB reading stage, the MIB is received through the PCCPCH and the parameters included in the MIB is read by the UE 200. In the SIB reading stage, SIB are ready by the UE 200 in light of the parameters set forth in the MIB.

Next at block B502, one or more preemption point(s) is defined (e.g., by the processor 201 of the UE 200) between the chunks. The preemption point may designate where the paging process for paging the second RAT, such as GSM in the current example, may be executed (i.e., the preemption points, which may correspond to the breaks in the chunks as described above). That is, in response to the WCDMA process being segmented into chunks in the manner described above, preemption points may be set between the synchronization phase and the frequency pull-in phase, between the frequency pull-in phase and the system information decoding phase, between the system information decoding phase and the system information reading phase.

Next at block B503, a first chunk of the WCDMA acquisition process may be executed (e.g., the processor 201 of the UE 200). As used herein, a first chunk may refer to the first chunk of the entire WCDMA acquisition process (i.e., the synchronization phase), or a chunk that is prior in time than a next chunk.

Next at block B504, it may be determined whether to execute the paging process for paging GSM by tuning away from WCDMA and tuning in to GSM. Such determination may be made by the user of the UE 200 through the user interface 203 of the UE 200, or by the UE 200 automatically according to algorithms stored on the memory 202 and executed by the processor 201 of the UE 200. In some embodiments, the UE 200 may always be configured to execute the GSM paging process at the preemption points between the chunks (i.e., the paging process for paging GSM may always be executed and the outcome of block B504 is always YES). As such, the decision made at block B504 may be omitted.

In some embodiments, the UE 200 may be configured to check for an outstanding GSM paging request to the UE 200 by tuning to GSM for a brief period of time and “listening” for a paging message for a predetermined period of time (e.g., 5 ms, 10 ms, or 15 ms). In further or alternative embodiments, the UE 200 may check its memory (e.g., the memory 202 of the UE 200) whether the UE 200 had already received a paging request and a paging response is required to be sent by the UE 200 to complete the paging GSM. When it is found that there is an outstanding GSM paging request to the UE 200 and/or when there is an outstanding GSM paging response that is required to be sent by the UE 200, the UE 200 may determine that the paging process for paging GSM is required to be executed. The UE 200 may be configured to determine whether to execute the paging process for paging GSM in response to of the first chunk being completely executed, or in response to the first chunk yielding a particular set of data as described.

When it has been determined that the paging process for paging GSM is to be executed, then next at block B505 (B504:YES), a time interval is determined for paging GSM (e.g., the processor 201 of the UE 200). In some embodiments, the process for paging GSM proceeds without determining the time interval (i.e., the paging process proceeds until paging is completed, without setting a period of time before executing the paging). For example, the paging process for paging GSM may be executed for a number of frames (the number of frames being 1 to N), where each frame may be associated with a frame decoding time. In other words, the paging process for paging GSM may be executed for N multiplied by the frame decoding time of each frame. The UE 200 may be configured to determine (through the user interface 203 of the UE 200) the number frames to be executed (the number being equal or greater than 1, or equal or less than N) based on various environmental factors, such as, but not limited to, signal condition (e.g., signal strength), background noise, and the like. For instance, the signal condition is inversely proportional to the number of frames to be executed (i.e., a lesser number of frames may be executed when the signal condition is determined to be relatively good, as compared to when the signal condition is determined to be relatively bad, the UE 200 may determine to execute a paging process a greater number of frames). As such, given that the environmental factors may change over time, the number of pages to be executed at each preemption point may differ.

In other embodiments, a paging time interval is determined before the execution of GSM paging, such that the RF resources 204 may be tuned away from GSM to WCDMA for acquiring WCDMA (executing the next chunk) at the end of the time interval. In particular embodiments, the paging time interval may correspond to a predetermined number of pages to be executed at each preemption point (where the number of pages to be executed may be the same number of different for two or more preemption points based on suitable factors).

Next at block B506, paging process for GSM may be carried out by the processor 201 of the UE 200 when the UE 200 configures the RF resources 204 to tune to GSM and perform the paging process, which may include page demodulation, measurement, and reselection based on measurement. In particular, the UE 200 may receive receives a paging request, decode or otherwise process the paging request (with the processor 201), and send a paging response through the network (with the RF resources 204) within the paging response time. As described, the UE 200 may be configured to decode the paging request for a number of frames.

Next at block B507, the processor 201 of the UE 200 may determine whether the acquisition process of the WCDMA has been completed. Such determination may be made in response to the completion of paging GSM, or, in response to the determination that the paging process for paging GSM is not to be executed (B504:NO). The UE 200 may be configured to check whether there is another chunk (another chunk after the first chunk) to be executed (e.g., by checking a chunk index value that is associated with the particular chunk, the chunk index value indicates the chunk's position in the acquisition process). Alternately, check whether the first chunk is the last chunk of the acquisition process.

When it is determined that the acquisition process of WCDMA is completed, the next at block B508 (B507:YES), the acquisition of WCDMA is ended (i.e., WCDMA has been acquired, and the UE 200 is camped on a WCDMA network). The UE 200 may now acquire data and services from the base station associated with the WCDMA network.

On the other hand, when it is determined that the acquisition process is not completed, next at block B509 (B507:NO), a next chunk of the WCDMA acquisition process is executed (e.g., by the processor 201 of the UE 200). As used herein, the next chunk may mean the chunk of the acquisition process after the first chunk. Then, in response to the completion of executing the next chunk of the acquisition process at block B509, the determination is made at block B504 as to whether to execute a paging process for paging the second RAT. The split acquisition process of WCDMA 500 then proceeds according to what is illustrated following block B504.

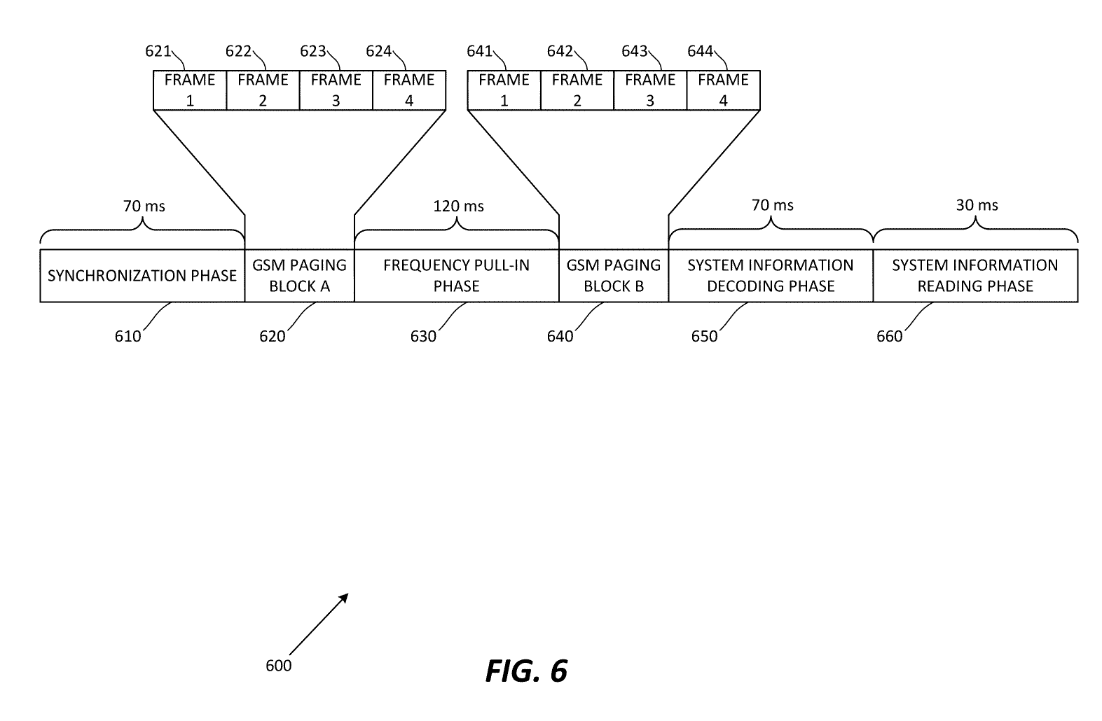

FIG. 6 illustrates an example of a WCDMA split acquisition process of 600 according to various embodiments. With reference to FIGS. 1-6, the WCDMA acquisition process example 600 has been segmented into four acquisition chunks. The first chunk may include the synchronization phase 610, the second chunk may include the frequency pull-in phase 630, the third chunk may include the system information decoding phase 650, and the fourth chunk may include the system information reading phase 660. Each chunk may include one or more phases, such as, but not limited to, the stages corresponding to the phases associated with the chunks. For example, the slot timing determination stage, the frame timing determination stage, and the PN sequence searching stage may be in the synchronization phase 610, and are thus in the first chunk. The frequency pulling-in stage may be associated with the frequency pulling-in phase 630, and is thus in the second chunk. The search result listing stage, the triaging stage, the PCCPCH set up stage, transmitting time interval determination stage, and the MIB reading stage are associated with the system information decoding phase 650. The SIB reading phase is in the fourth chunk, with the system information reading phase 660.

Each chunk of the WCDMA split acquisition process 600 may be associated with an effective execution time. For example, as illustrated in FIG. 6, the synchronization phase 610 may be associated with an effective execution time of 70 ms; the frequency pull-in phase may be associated with an effective execution time of 120 ms; the system information decoding phase may be associated with an effective execution time of 70 ms, and the system information reading phase may be associated with an effective execution time of 30 ms.

The GSM paging processes blocks 620, 640 of the second RAT may be inserted or otherwise defined between two WCDMA acquisition chunks that are adjacent in time (e.g., at the preemption points as described). For example, the GSM paging block A 620 may take place after the synchronization phase 610 and before frequency pull-in phase 630, and the GSM paging block B 640 may take place after the frequency pull-in phase 630 and before the system information decoding phase 650. In some embodiments, the GSM paging block A 620 may be initiated in response to the completion of the synchronization phase 610; the frequency pull-in phase 630 may be initiated in response to the completion of the GSM paging block A 620; the GSM paging block B 640 may be initiated in response to the completion of frequency pull-in phase 630; the system information decoding phase 650 may be may be initiated in response to the completion of the GSM paging block B 640. A preemption point may be defined between the system information decoding phase 650 and the system information reading phase 660. However, the paging process for paging GSM may not be executed at the preemption point, as the UE 200 may have determined not to execute the paging process for paging GSM in the manner described. Accordingly, the system information decoding phase 650 and the system information reading phase 660 may be executed continuously, such that no break exists between the two.

The paging process for paging GSM may be executed for a number of frames, where the number of frames define the time for which the paging process for paging GSM is executed. In some embodiments, a first number of frames may be executed when signal conditions are determined to be favorable (e.g., by the processor 201 of the UE 200) while a second number of frames may be executed when signal conditions are determined to be less than favorable (e.g., by the processor 201 of the UE 200). In some embodiments, the first number of frames (e.g., 3, 4, or 5) may be different, for example, greater than the second number of frames (e.g., 1 or 2). In particular embodiments, 4 frames (or other suitable number of frames) may be executed during the GSM paging block A, where each frame of GSM may take 4.61 ms. For example, in GSM paging, 4 frames may be executed when the signal condition may be considered “bad,” i.e., when one or more indicator values indicating signal condition correspond to a predetermined level of signal condition. Thus, frame 1 621, frame 2 622, frame 3 623, and frame 4 624 are used in the paging process of GSM to decode the paging request for GSM paging block A. Similarly, frame 1 641, frame 2 642, frame 3 643, and frame 4 644 are used in the paging process of GSM to decode the paging request for GSM paging block B.

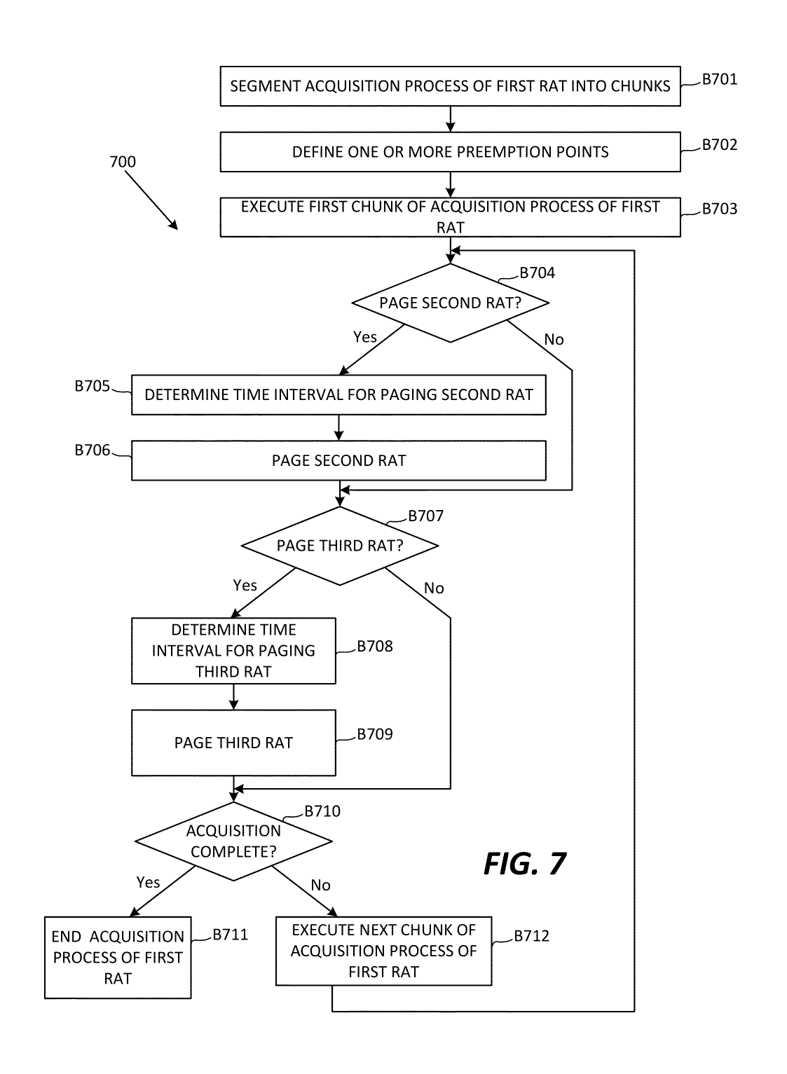

FIG. 7 is a process flow chart illustrating a split acquisition process 700 for acquiring a first RAT and paging two other RATs according to various embodiments, where the first RAT, the second RAT, and the third RAT are different RATs. The paging processes for paging both second RAT and the third RAT may be executed, with the RF resources 204 of the UE 200, to improve the paging success rate of both the second RAT and the third RAT. According to various embodiments, the split acquisition process may be implemented, for example, by the processor 201 of the UE 200 (e.g., FIG. 2)

According to FIGS. 1-7, at block B701, an acquisition process of the first RAT may be segmented into two or more chunks (e.g., by the processor 201 of the UE 200) as described with respect to block B301 (and block B501). The first RAT may be WCDMA or another suitable RAT. Next at block B702, one or more preemption points are defined between the chunks in the manner described with respect to block B302 (and block B502). Then, at block B703, the first chunk of the acquisition process is executed in similar fashion as described for block B303 (and block B503).

Next at block B704, the processor 201 of the UE 200 may determine whether to execute a paging process for paging the second RAT according to that which is described with respect to block B304 (and block B504). When the paging process for paging the second RAT is determined, then, next at block B705 (B704:YES), a time interval for paging the second RAT is determined in the manner such as, but not limited to, what is described with respect to block B305 (and block B505). Next at block B706, the UE 200 may be configured to execute a paging process for paging the second RAT in the manner such as, but not limited to, what is described with respect to block B306 (and block B506).

Next, in response to the completion of the paging process for the second RAT, or in response to the determination that the paging process for paging the second RAT is to be executed (B704:NO), the processor 201 of the UE 200 may determine whether a paging process for paging a third RAT may be executed. The processor 201 of the UE 200 may determine whether the paging process for paging the third RAT is to be executed in a manner similar to described with respect to block B304 (and blocks B504 and B704). When the paging process for paging third RAT is determined to be executed, then, next at block B708 (B707:YES), a time interval for paging the third RAT is determined in the manner such as, but not limited to, what is described with respect to block B305 (and blocks B505 and B705). Next at block B709, the processor 201 of the UE 200 may be configured to execute a paging process for paging the third RAT in the manner such as, but not limited to, what is described with respect to block B306 (and blocks B506 and B706). Given that the second RAT and the third RAT may be separate RATs, the paging process for paging these RATs may be different as well.

Next at block B710, the processor 201 of the UE 200 may determine whether the acquisition process of the first RAT is completed (e.g., in a manner similar to described with respect to B307 of FIG. 3 and/or block B507 of FIG. 5), in response to the completion of paging the third RAT, or in response to the determination that the paging process for paging third RAT is not to be executed (B707:NO). Whereas, it is determined that the acquisition process of the first RAT is completed (B710:YES), then the acquisition process of the first RAT is completed, at block B711. On the other hand, if it is determined that the acquisition process for the first RAT is not completed (B710:NO), then the UE 200 may be configured to execute a next chunk of the first RAT acquisition process, at block B712. Following block B712, a determination is made as to whether the paging process for paging the second RAT is to be executed (e.g., at B704), and the split acquisition process 700 proceeds as described.

In some embodiments, the steps described herein with respect to paging the second RAT (e.g., blocks B704-B706) and paging the third RAT (e.g., blocks B707-B709) may be executed (e.g., by the processor 201 of the UE 200) in sequential order, such that the determination of whether to execute a paging process for paging the third RAT (paging the third RAT) may be made in response to the completion of paging of the second RAT. In other embodiments, one or more of the steps described with respect to paging the second RAT and one or more of the steps described with respect to paging the third RAT may be executed in parallel (e.g., at least a portion of the steps are performed simultaneously).

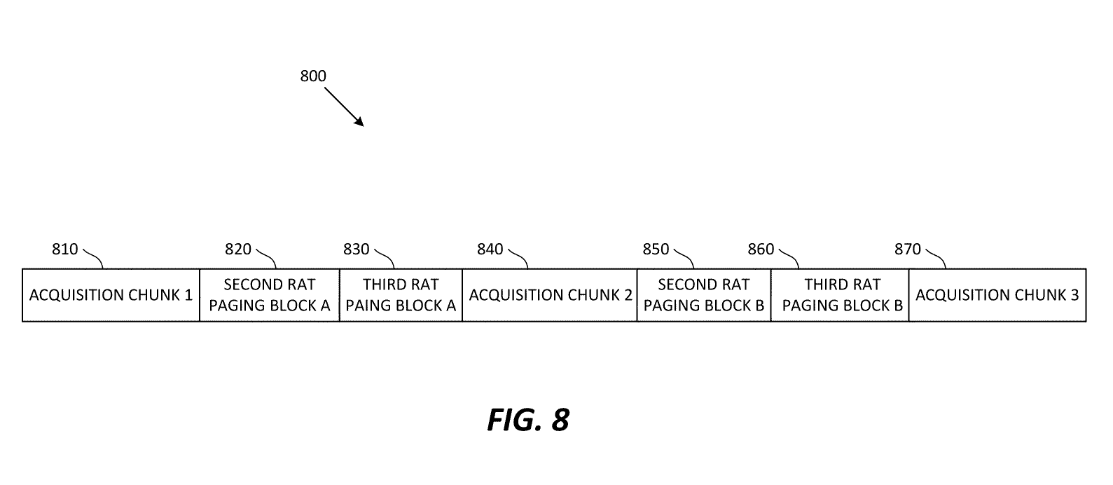

FIG. 8 is a block diagram illustrating an example of a split acquisition process 800 for a first RAT and paging two other RATs according to various embodiments implemented by the UE 200 (e.g., refer to FIG. 2). Referring to FIGS. 1-8, the acquisition process of the first RAT may include acquisition chunk 1 810, acquisition chunk 2 840, and acquisition chunk 3 870. The split acquisition process 800 has been segmented into three acquisition chunks 810, 840, 870 in the manner described, such that each chunk may include one or more phases (and the corresponding stages within each of the phases) or one or more stages.

The paging blocks 820, 850 of the second RAT and the paging blocks 830, 860 of the third RAT may be inserted or otherwise defined between two acquisition chunks that are adjacent in time (e.g., at the preemption points as described). Each acquisition block 820, 830, 850, 860 may include one or more processes (e.g., the second RAT paging block A and the second RAT paging block B may include steps represented by blocks B704-B706), and the third RAT paging block A and the third RAT paging block B may include steps represented by blocks B707-B709.

In some embodiments, at one or more preemption points, one or more paging processes for paging RATs (e.g., the second RAT and the third RAT) may be executed. In other embodiments, the paging process for paging only one RAT may be executed at any preemption point to assure that the acquisition process of the first RAT is not deprived of the RF resources 204 for a considerable period of time. As such, the paging process for paging the second RAT may be executed at one preemption point, and the paging process for paging the third RAT that is separate from the second RAT may be executed at a separate preemption point (e.g., a next preemption point). In addition, paging processes for paging additional RATs (e.g., a fourth RAT, a fifth RAT, . . . a Nth RAT) supported by the UE 200 may be executed at one or more preemption points similar to the manner described, (e.g., paging processes for paging at least one RAT may be executed at one preemption point while paging processes for paging some other RAT(s) may be executed at the same or different preemption point).

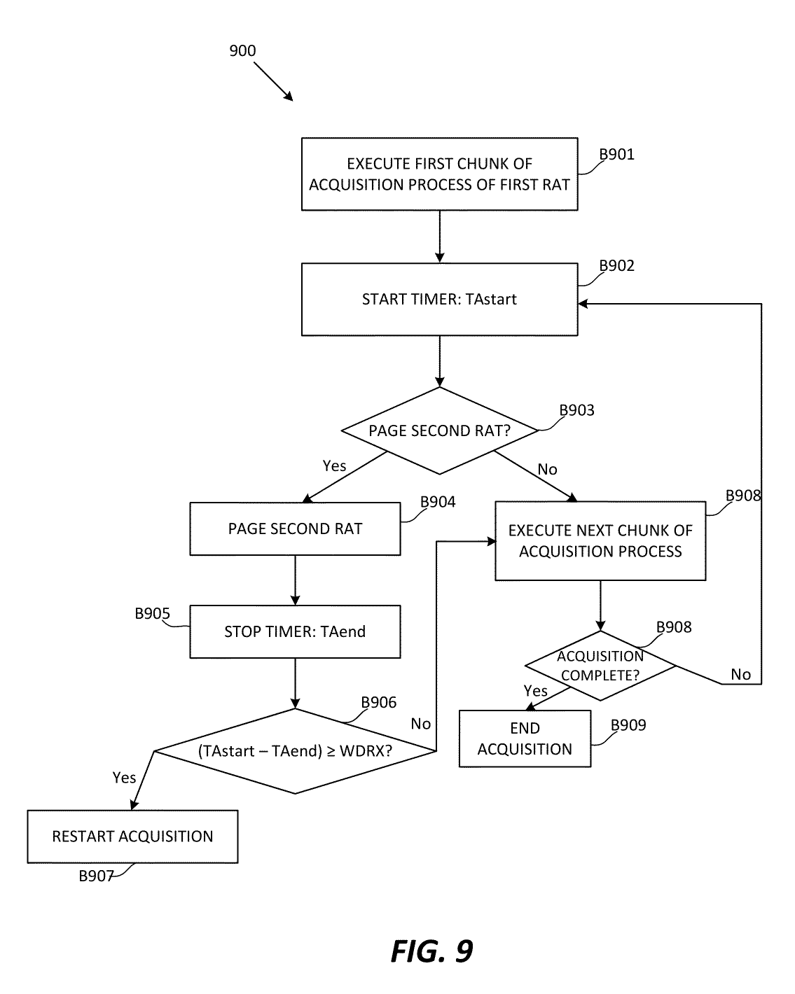

FIG. 9 illustrates a stale sample prevention process 900 for acquiring a first RAT according to various embodiments. The process 900 may be implemented by the UE 200 (e.g., refer to FIG. 2). With reference to FIGS. 1-9, when the paging process holds the RF resources 204 for too long, the data (referred to as “samples”) used in the acquisition process of the first RAT may become “stale,” e.g., the duration for which the samples are valid, may expire. Thus, the UE 200 may be configured to time the paging process and compare the time with a predetermined time interval, where the predetermined time interval defines a time period for which the acquisition sample are valid. If the time for the paging process exceeds the predetermined time interval (samples are “stale”), the acquisition process restarts from the beginning (e.g., restart from the initial chunk of the acquisition process). If the time for the paging process does not exceed the predetermined time interval (samples are valid), and the acquisition process may continue to the next chunk (or end).

First at block B901, a first chunk of the acquisition process of the first RAT is executed as described (e.g., by the processor 201 of the UE 200). In response to obtaining the resulting samples (or other types of data) through the processes of the first chunk (e.g., the first chunk has been completed), a timer is started, at B902. The timer may be an internal or external timer residing on the UE, or it can be other types of timer implemented by the processor 201 and the memory 202 of the UE 200. The time at which the timer is started is recorded as TAstart.

Next, at block B903, the processor 201 of the UE 200 may determine whether the paging process for paging second RAT is to be executed, according to description herein. When it is determined that the paging process for paging second RAT is to be executed (B903:YES), then next at block B904, the UE 200 may execute a paging process for paging the second RAT as described. In response to the completion of paging the second RAT, the timer is stopped, and time is noted as TAend, at block B905.

Then, the UE 200, through the processor 201, may be configured to determine whether the time period timed by the timer (i.e., TAstart-TAend), is greater than or equal to a threshold value. In some embodiments, the threshold value may be discontinuous reception (DRx) cycle time, which is the time beyond which the samples would have been stale. In particular example related to WCDMA acquisition, the threshold value may be a WCDMA DRx, where if the time that the UE 200 has taken to execute a paging process for paging another RAT (e.g., GSM) exceeds the WCDMA DRx cycle time, then it is deemed that the samples are stale. The DRx cycle may define a periodicity of the DRX process, where the longer the DRx cycle, the longer the UE 200 may be in a sleep state (idle mode), and the longer the delay before the UE 200 can respond to a paging message. In other embodiments, other suitable methods to assess whether the samples are stale may be implemented.

Thus, when the tune away time is greater than or equal to the threshold value (B906:YES), then the acquisition process of the first RAT is restarted (e.g., the initial block of the acquisition process is initiated), at block B907 (e.g., by the processor 201 of the UE 200). On the other hand, when the tune away time is less than the threshold value (B906:NO), or when the process 201 of the UE 200 determines that the paging process for paging the second RAT is not to be executed (i.e., the RF resources 204 are not tuned away from the first RAT (B903:NO)) then a next chunk of the acquisition process is executed at block B908. Next at block B908, the UE 200 determines whether the acquisition process is completed, as described. When the acquisition process is completed (B908:YES), then the acquisition process is ended, at block B909. On the other hand, if the acquisition process is not determined to be completed (B908:NO), then a timer is started (or restarted) at block B902, and the stale sample prevention process 900 proceeds as described.

In other embodiments, the UE 200 may execute paging processes for the other RATs for a predetermined time interval, such that the RF resources 204 of the UE 200 may be tuned away from paging and tuned in to acquisition (for processing the next chunk of the W acquisition process) at the expiration of the predetermined time interval, regardless of whether paging has been completed.

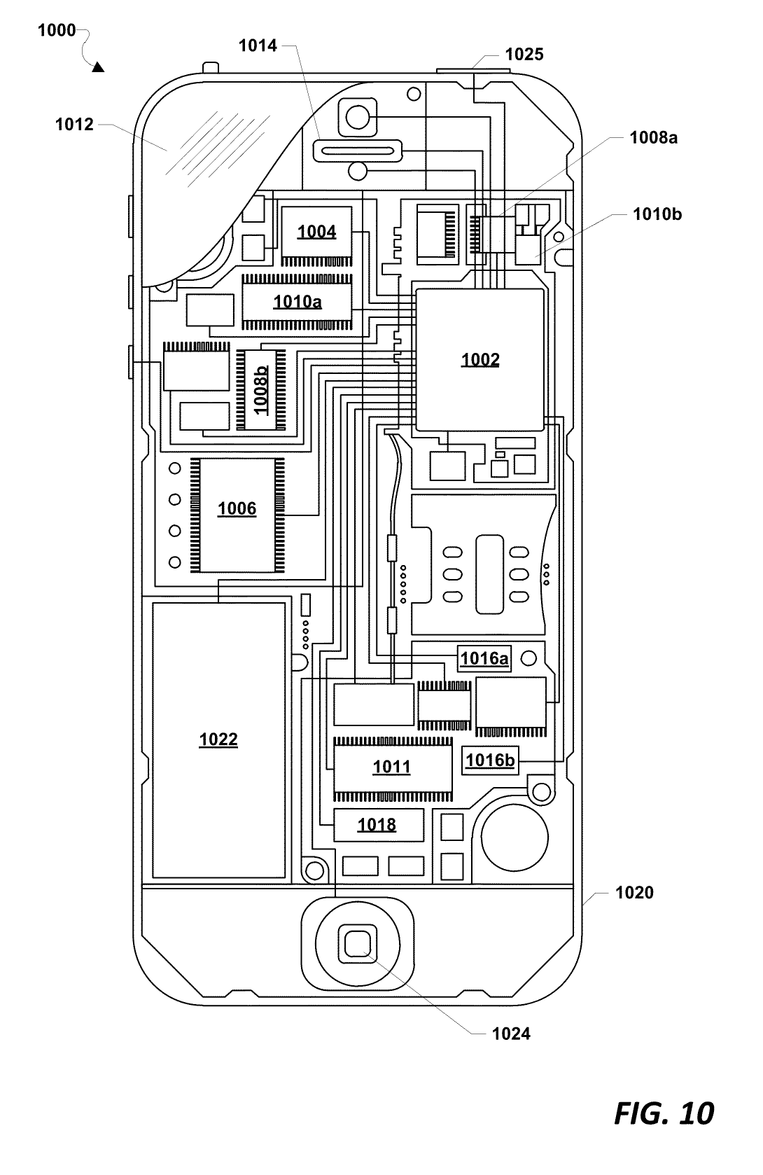

The various embodiments may be implemented in any of a variety of UEs, an example of which (UE 200 of FIG. 2, which may correspond to the UE 110 in FIG. 1) is illustrated in FIG. 10. As such, the UE 1000 may implement the process and/or the apparatus of FIGS. 1-9, as described herein.

With reference to FIGS. 1-10, the UE 1000 may include a processor 1002 coupled to a touchscreen controller 1004 and an internal memory 1006. The processor 1002 may correspond to the processor 201. The processor 1002 may be one or more multi-core integrated circuits designated for general or specific processing tasks. The internal memory 1006 may correspond to the memory 202. The memory 1006 may be volatile or non-volatile memory, and may also be secure and/or encrypted memory, or unsecure and/or unencrypted memory, or any combination thereof. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the UE 1000 need not have touch screen capability. The touch screen controller 1004, the touchscreen panel 1012 may correspond to the user interface.

The UE 1000 may have one or more cellular network transceivers 1008a, 1008b coupled to the processor 1002 and to two or more antennae 1010 and configured for sending and receiving cellular communications. The transceivers 1008 and antennae 1010a, 1010b may be used with the above-mentioned circuitry to implement the various embodiment methods. The UE 1000 may include two or more SIM cards 1016a, 1016b, corresponding to SIM A 205 and SIM B 206, coupled to the transceivers 1008a, 1008b and/or the processor 1002 and configured as described above. The UE 1000 may include a cellular network wireless modem chip 1011 that enables communication via a cellular network and is coupled to the processor. The one or more cellular network transceivers 1008a, 1008b, the cellular network wireless modem chip 1011, and the two or more antennae 1010 may correspond to the RF resources 204.

The UE 1000 may include a peripheral device connection interface 1018 coupled to the processor 1002. The peripheral device connection interface 1018 may be singularly configured to accept one type of connection, or multiply configured to accept various types of physical and communication connections, common or proprietary, such as USB, FireWire, Thunderbolt, or PCIe. The peripheral device connection interface 1018 may also be coupled to a similarly configured peripheral device connection port (not shown).

The UE 1000 may also include speakers 1014 for providing audio outputs. The UE 1000 may also include a housing 1020, constructed of a plastic, metal, or a combination of materials, for containing all or some of the components discussed herein. The UE 1000 may include a power source 1022 coupled to the processor 1002, such as a disposable or rechargeable battery. The rechargeable battery may also be coupled to a peripheral device connection port (not shown) to receive a charging current from a source external to the UE 1000. The UE 1000 may also include a physical button 1024 for receiving user inputs. The UE 1000 may also include a power button 1026 for turning the UE 1000 on and off.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for acquiring a first radio access technology (“RAT”), comprising:
segmenting an acquisition process of the first RAT into a plurality of chunks;
executing a first chunk of the acquisition process;
executing at least one portion of a paging process for paging a second RAT after the first chunk has been executed and before a second chunk is executed; and
executing the second chunk of the acquisition process;
wherein each of the plurality of chunks comprises a portion of the acquisition process.

2. The method of claim 1,
wherein the segmenting comprises defining a preemption point between the first chunk and the second chunk; and
wherein the executing the at least one portion of the paging process for paging the second RAT comprises executing the at least one portion of the paging process for paging the second RAT at the preemption point.

3. The method of claim 1, further comprising:
determining a paging time interval;
wherein the executing the at least one portion of the paging process for paging the second RAT comprises executing the at least one portion of the paging process for paging the second RAT within the paging time interval.

4. The method of claim 3, wherein the paging time interval is determined based, at least in part, on signal condition.

5. The method of claim 1, wherein the executing the at least one portion of the paging process for paging the second RAT comprises:
tuning RF resources away from the first RAT; and
tuning the RF resources to the second RAT.

6. The method of claim 1, wherein the executing the at least one portion of the paging process for paging the second RAT comprises receiving a page for the second RAT from a network associated with the second RAT.

7. The method of claim 1, further comprising:
defining the acquisition process of the first RAT as a plurality of stages;
wherein the acquisition process is segmented based, at least in part, on the defined plurality of stages.

8. The method of claim 7, wherein the plurality of stages comprises one or more of 1) determining slot timing, 2) determining frame timing, 3) searching for pseudo-noise sequence, 4) pulling in frequency, 5) listing search results, 6) triaging, 7) setting up a primary common control physical channel, 8) transmitting time interval determination, 9) reading one or more master information blocks, and 10) reading one or more system information blocks.

9. The method of claim 7, wherein the segmenting the acquisition process comprises grouping at least one stage of the plurality of stages in each chunk of the plurality of chunks.

10. The method of claim 9, wherein the segmenting the acquisition process comprises:
grouping the determining slot timing, the determining frame timing, and the searching for pseudo-noise sequence in a first chunk;
grouping the pulling in frequency in a second chunk;
grouping the listing search results, the triaging, the setting up a primary common control physical channel, the transmitting time interval determination, and the reading one or more master information blocks in a third chunk; and
grouping the reading one or more system information blocks in a fourth chunk.

11. The method of claim 1, wherein the acquisition process is segmented based, at least in part, on processing time.

12. The method of claim 1, wherein the first RAT and the second RAT are a same RAT.

13. The method of claim 1, wherein the first RAT is different from the second RAT.

14. The method of claim 1, wherein the first RAT and the second RAT are associated with a same subscription.

15. The method of claim 1, wherein the first RAT is associated with a different subscription from a subscription associated with the second RAT.

16. The method of claim 1, further comprising:
monitoring a time period in which the second RAT is being paged; and
restarting the acquisition process when the monitored time period exceeds a predetermined threshold.

17. The method of claim 1, further comprising executing at least one portion of one or more additional paging processes at the preemption point, each additional paging process for paging an additional RAT.

18. The method of claim 17, further comprising:
determining an additional paging time interval associated with the each additional paging process; and
executing the at least one portion of each additional paging process within the additional paging time interval.

19. An apparatus for acquiring a first radio access technology (“RAT”), comprising:
at least one set of RF resources; and
a processor configured to:
segment an acquisition process of the first RAT into a plurality of chunks;
execute a first chunk of the acquisition process;
execute at least one portion of a paging process for paging a second RAT after the first chunk has been executed and before a second chunk is executed; and
execute the second chunk of the acquisition process,
wherein each of the plurality of chunks comprises a portion of the acquisition process.

20. The apparatus of claim 19,
wherein to segment comprises to define a preemption point between the first chunk and the second chunk; and
wherein to execute the at least one portion of the paging process for paging the second RAT comprises to execute the at least one portion of the paging process for paging the second RAT at the preemption point.

21. The apparatus of claim 19, the processor is further configured to:
determine a paging time interval;
wherein to execute the at least a portion of the paging process for paging the second RAT comprises to execute the at least one portion of the paging process for paging the second RAT within the paging time interval.

22. The apparatus of claim 21, wherein the paging time interval is determined based, at least in part, on signal condition.

23. The apparatus of claim 19, wherein the processor is configured to execute the at least one portion of a paging process for paging the second RAT by:
tuning the at least one set of RF resources away from the first RAT; and
tuning the at least one set of RF resources to the second RAT.

24. The apparatus of claim 19, wherein to execute the at least one portion of the paging process for paging the second RAT comprises to receive a page for the second RAT from a network associated with the second RAT.

25. The apparatus of claim 19, wherein the acquisition process of the first RAT is defined as a plurality of stages, wherein the acquisition process is segmented based, at least in part, on the defined plurality of stages.

26. The apparatus of claim 25, wherein the plurality of stages comprises one or more of 1) determining slot timing, 2) determining frame timing, 3) searching for pseudo-noise sequence, 4) pulling in frequency, 5) listing search results, 6) triaging, 7) setting up a primary common control physical channel, 8) transmitting time interval determination, 9) reading one or more master information blocks, and 10) reading one or more system information blocks.

27. The apparatus of claim 25, wherein to segment the acquisition process comprises to group at least one stage of the plurality of stages to each chunk of the plurality of chunks.

28. The apparatus of claim 27, wherein to segment the acquisition process comprises:
to group the determining slot timing, the determining frame timing, and the searching for pseudo-noise sequence in a first chunk;
to group the pulling in frequency in a second chunk;
to group the listing search results, triaging, the setting up a primary common control physical channel, the transmitting time interval determination, and the reading one or more master information blocks in a third chunk; and
to group the reading one or more system information blocks in a fourth chunk.

29. The apparatus of claim 19, the processor is further configured to:
monitor a time period in which the second RAT is being paged; and
restart the acquisition process when the monitored time period exceeds a predetermined threshold.

30. An apparatus, comprising:
means for segmenting an acquisition process of the first RAT into a plurality of chunks;
means for executing a first chunk of the acquisition process;
means for executing at least one portion of a paging process for paging a second RAT after the first chunk has been executed and before a second chunk is executed; and
means for executing the second chunk of the acquisition process,
wherein each of the plurality of chunks comprises a portion of the acquisition process.
